(19) United States
(12) Patent Application Publication
(10) Pub. No.: US 2014/0129735 A1
(43) Pub. Date: May 8, 2014

(54) METHOD AND NODE FOR SUPPORTING ROUTING VIA INTER AS PATH

(71) Applicants: Tomas Thyni, Jarfalla (SE); Mats Forsman, Ronninge (SE); Annikki Welin, Solna (SE)

(72) Inventors: Tomas Thyni, Jarfalla (SE); Mats Forsman, Ronninge (SE); Annikki Welin, Solna (SE)

(73) Assignee: Telefonaktiebolaget L M Ericsson (publ), Stockholm (SE)

(21) Appl. No.: 14/128,317

(22) PCT Filed: Jun. 23, 2011
(86) PCT No.: PCT/SE2011/050841

§ 371 Date: Dec. 20, 2013

(51) Int. Cl. H04L 12/721

(52) U.S. Cl. CPC H04L 45/14
USPC 709/241

(57) ABSTRACT

The present invention relates to a method in a border node of an Autonomous System (AS) and a border node comprising a border route control unit. The border node is configured to route data packets from a source node in an originating Autonomous System to a destination node in a terminating Autonomous System, possibly via intermediate autonomous systems. The method includes determining one inter autonomous system path or multiple inter AS paths constituting a route or multiple routes, respectively, between the originating autonomous system and terminating autonomous system based on at least an energy consumption metrics of transit paths through an own autonomous system and other autonomous systems and a total energy consumption metric for each possible inter autonomous system path. The border node is adapted to store the route or the multiple routes in a border gateway routing table.

### TECHNICAL FIELD

The technical field treated in this document is related to routing of data streams. More specific, this document provides embodiments of methods and nodes for supporting routing of data packet flows between autonomous systems.

### BACKGROUND

The Internet is formed by Autonomous Systems comprising communications networks. An Autonomous System (AS) is defined as a collection of connected Internet Protocol (IP) routing prefixes under the control of one or more network operators that announces a common, clearly defined routing policy to the Internet. An AS is managed and supported by an Internet Service Provider (ISP) or a Network Service Provider (NSP). An AS is roughly, a part of the Internet owned and administrated by the same organization. The AS range in size from small Internet Service Providers (ISPs) or Network Service Providers (NSPs) to huge international corporations and Operators. An ISP or NSP (ISP/NSP) may manage and support a number of Autonomous Systems (ASs) of the Internet. For each Autonomous System the ISP/NSP must have an officially registered Autonomous System Number (ASN). The Autonomous System Numbers (ASNs) are assigned in blocks by the Internet Assigned Numbers Authority (IANA) to Regional Internet Registries (RIRs). The appropriate Regional Internet Registry (RIR) then assigns AS numbers to ASs within its designated area from the block assigned by the IANA.

A unique ASN is allocated to each AS for use in Border Gateway Protocol (BGP) routing, enabling routing of data packets in the flow of data packets called data traffic. Roughly, BGP handles the exchange of network reachability information between ASs and the determination of routes from this information.

An important characteristic of BGP is its flexibility to connect together any interworking of ASs using an arbitrary topology. The only requirement is that each AS has at least one router that is able to run BGP and that the router is connected to at least one BGP router of another AS. BGP is adapted to handle a set of ASs connected in a full mesh topology, a partial mesh, a chain of ASs linked as one to the next, or any other configuration. In a full mesh topology, each AS is connected to each of the other ASs. BGP is also configured to handle changes of topology that may occur over time.

An important feature of BGP is that it doesn't handle any information about what happens within an AS. This is of course an important prerequisite to the notion of an AS being autonomous—it has its own internal topology and uses its own choice of routing protocols to determine routes. BGP is only configured to take the information conveyed to it from the AS and share it with other ASs. Creating a BGP internetwork begins with the designation of certain routers in each AS configured to run the protocol. In BGP parlance, these are called BGP speakers since they speak the BGP “language”.

An autonomous system may contain many routers which are connected in an arbitrary topology. Some of these routers are only connected to routers within the AS and are therefore called internal routers, while some of the routers are also connected to other ASs. Routers connected to other ASs are denoted in BGP as border routers. According to other protocol parlance, such routers are called boundary routers, edge routers, etc. When a BGP speaker in one AS is linked to a BGP speaker in another AS, they are denoted neighbours. The direct connection between them allows them to exchange information about the ASs of which they are a part. The neighbours exchange route information using the BGP messaging system. A BGP speaker may be connected to more than one other speaker. A BGP speaker may have relationship with other BGP routers both within its own AS and outside its AS. A neighbour within the AS is called an internal peer, while a neighbour in another AS is an external peer. BGP between internal peers is sometimes called Internal BGP (IBGP) while use of the protocol between external peers is denoted External BGP (EBGP). The two protocols are similar in many ways, but differ in certain areas, especially regarding path attributes and route selection.

A peer connection between two BGP speakers may be either a direct link, or an indirect link. The BGP protocol uses the Transfer Control Protocol (TCP) as transport protocol between BGP routers. This allows the BGP routers to establish BGP sessions and then exchange routing information using the messaging system. It is also the means by which the actual end user data traffic moves between autonomous systems. External peers are normally connected directly, while internal peers are often linked indirectly.

The information about the path of each route is stored in the Routing Information Base (RIB), even denoted Routing table, of each BGP speaker in the form of BGP path attributes. These attributes are used to advertise routes to networks when BGP devices send out Update messages. The storing, processing, sending and receiving of path attributes is the process by which routers decide how to create routes.

There are several different path attributes, each of which describes a particular characteristic of a route. Attributes are divided into different categories based on their level of importance and specific rules designed to manage their propagation. The most important path attributes are called Well-known mandatory attributes. Every BGP speaker must recognize and process these, but only some are required to be sent with every route. Other attributes are optional and may not be implemented.

The object of the BGP is to facilitate the exchange of route information between BGP devices, so that each router is able to determine efficient routes to each of the networks in an IP internetwork. This means that descriptions of routes are the key data for BGP routers. Every BGP speaker is responsible for managing route descriptions according to specific guidelines established in the BGP standards.

The routine operation, or main task operations, of BGP requires BGP speakers to store, update, select and advertise routing information.

One of the main tasks is to store routes, i.e. route storage. Each BGP router stores information in a set of special databases about how to reach the other routing areas, i.e. autonomous systems. It also uses databases to hold routing information received from other devices. Route update occurs when a BGP router receives an Update from one of its peers. The BGP device must decide how to use this information. Special techniques are applied to determine when and how to use the information received from peers to properly update the stored route information in the device.

Another of the main tasks of the BGP is to select a route, i.e. route selection. Each BGP uses the information in its route database to select good routes to each AS on the internetwork. Further, each BGP speaker regularly tells its peers what it knows about various networks and methods to reach them. This is called route advertisement and is accomplished using BGP Update messages.

Once BGP speakers have made contact and a link has been established using Open messages, said routers begin the actual process of exchanging routing information. Each BGP router uses a BGP Decision Process to select routes to be advertised to its peers. This routing information, even denoted reachability information, is advertised by inserting the information into BGP Update messages. Each BGP Update message comprises either one or both of following:

Route Advertisement: The characteristics of a single route.

Route Withdrawal: A list of networks that are no longer reachable.

Only one route can be advertised in an Update message, but several can be withdrawn. This is because the withdrawing of a route is simple: it requires simply the address of the network, i.e. the AS, for which the route is being removed. In contrast, a route advertisement requires fairly complex set of path attributes to be described, which takes up a significant amount of space.

Thus, BGP routers share network reachability information for making path or route selection. This information includes information on the list of ASs that a certain path traverses. This information is sufficient to construct an IP reachability map, i.e. a Routing Information Base, Routing Table, based on AS connectivity and policy decisions at the AS border, which policy decisions is based on policy rules that may be enforced. Route/Path selection is therefore based on several BGP criteria's distributed between the ASs as path attributes in Update messages. BGP routers may receive multiple advertisements for the same route from multiple sources. In general, it only selects one route as the best route. The route is then added to the Routing Information Base (Routing Table).

The route selection and the policies are based on business models. These business models may favour route selection based on the number of ASs traversed, i.e. AS-hops. If shortest AS path policy is used, in case of two equal long AS paths, there is no information available about internal routing cost in each AS domain. Consequently, the decision is based on AS-hop only.

There is no central Internet authority dictating to any Internet service Provider which other ASs to connect to. The number of ASs increases by approximately 2 400 new ASs every year. This means that the amount of information that each AS has to maintain, handle and process consumes more and more energy. The increasing energy consumption of the Internet is not yet a great problem, but as the number of ASs is increasing rapidly, this will become a great problem for the Internet Service Providers running the ASs.

### SUMMARY

One object of this document is to address said problem and provide a way of reducing the energy consumption in the Internet.

Said object is achieved by providing embodiments of a method and nodes for supporting routing of data packet flows between end-users via autonomous systems, wherein said routing is based on routing policies and route selections resulting in more energy efficient transfer of data packet traffic through the Internet.

According to one aspect, embodiments of a method in a border node of an autonomous system are provided. The border node is configured to route data packets from a source node in an originating Autonomous System to a destination node in a terminating Autonomous System, possibly via intermediate autonomous systems. The method comprises determining of an energy consumption metric for each transit path between the border node and another border node within the Autonomous System. Further, the method comprises receiving from other border nodes of the own autonomous system and from other autonomous systems energy consumption metrics of transit paths through the own autonomous system and other autonomous systems. The method determines one inter autonomous system path or multiple inter AS paths constituting a route or multiple routes, respectively, between the originating autonomous system and terminating autonomous system including any intermediate autonomous system based on at least said energy consumption metrics of transit paths through the own autonomous system and other autonomous systems giving a total energy consumption metric for each possible inter autonomous system path. The method may also store the route or multiple routes based on at least the total energy consumption metrics in a routing table in the node.

According to another aspect, embodiments of a border node of an autonomous system are provided. The border node and embodiments thereof comprise a border route control unit for routing data packets from a source node in a originating autonomous system to a destination node in a terminating autonomous system, possibly via intermediate autonomous systems. The border route control unit is configured to determine an energy consumption metric for each transit path between the border node and another border node within the autonomous system and to receive from other border nodes of the own autonomous system and from other autonomous systems energy consumption metrics of transit paths through the own autonomous system and other autonomous systems. The route control unit is further configured to determine one inter autonomous system path or multiple inter AS paths constituting a route or multiple routes, respectively, between the originating Autonomous System and terminating Autonomous System including any intermediate Autonomous System based on at least said energy consumption metrics of transit paths through the own autonomous system and other autonomous systems giving a total energy consumption metric for each possible inter autonomous system path. The route control unit may further be configured to store the route or the multiple routes based on at least the total energy consumption metrics in a routing table in the node.

Further aspects and embodiments are enclosed in the dependent claims.

One advantage is that the present embodiments provide support for routing of data packet flows between end-users via autonomous systems, wherein said routing is based on routing policies and route selections resulting in more energy efficient transfer of data packet traffic through the Internet.

Further one advantage is that the embodiments provide an end-to-end update of energy consumption metrics, i.e. not only neighbour peer nodes in other autonomous systems connected to an autonomous system will receive the current energy consumption metrics, but all autonomous systems having peer nodes will receive the current energy consumption metrics.

Another advantage is that the present embodiments are easily implemented in existing internetwork and autonomous systems.

### BRIEF DESCRIPTION OF THE DRAWINGS

The foregoing, and other, objects, features and advantages of the present invention will be more readily understood upon reading the following detailed description in conjunction with the drawings in which:

FIG. 1 is a block diagram illustrating a descriptive example of a structure of interworking autonomous systems in which devices, systems and methods described herein may be implemented;

FIG. 2 is a block diagram showing some embodiments of a node;

FIG. 3 is a flowchart according to some embodiments;

FIG. 4 is a flowchart according to some other embodiments;

FIG. 5 is a block diagram illustrating a descriptive example of the structure of interworking autonomous systems according to FIG. 1, but wherein new energy cost metrics are set.

### DETAILED DESCRIPTION

In the following description, for purposes of explanation and not limitation, specific details are set forth, such as particular circuits, circuit components, techniques, etc. in order to provide a thorough understanding of the present invention. However, it will be apparent to one skilled in the art how the present invention and other embodiments that depart from these specific details may be practiced. In other instances, detailed descriptions of well known methods, devices, and circuits are omitted so as not to obscure the description of the present invention with unnecessary detail.

In BGP, and throughout this description, routes may also be denoted paths. Routes and paths are considered as equivalent concepts.

BGP between internal peers is sometimes called Internal BGP (IBGP) while use of the protocol between external peers is denoted External BGP (EBGP). The two protocols are similar in many ways, but differ in certain areas, especially regarding path attributes and route selection. The following description is mainly restricted to External BGP.

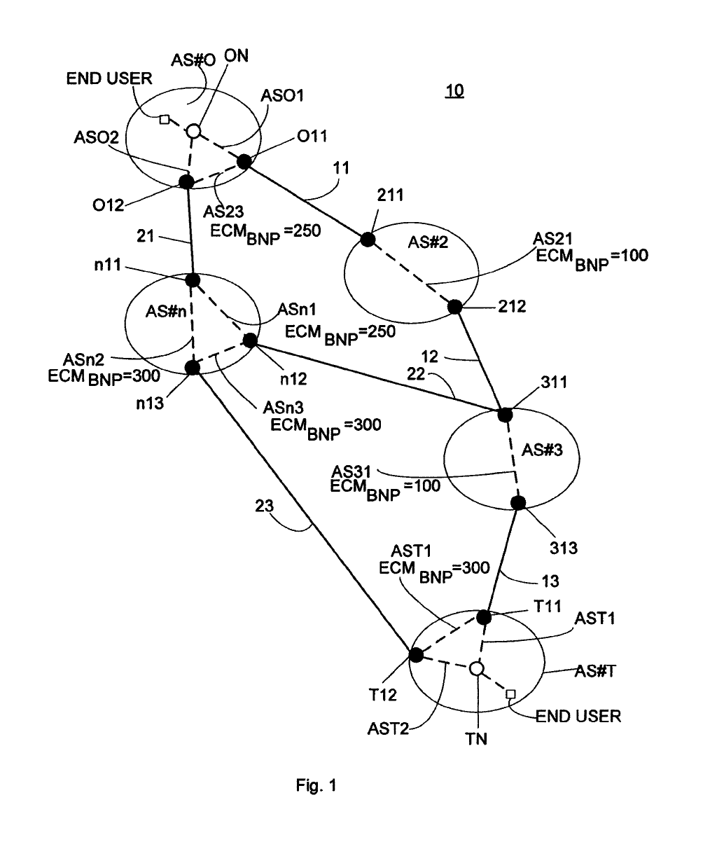

FIG. 1 is a schematic illustration of an internetwork structure comprising five autonomous systems.

Each Autonomous System (AS) has at least one communications network comprising routing nodes for routing data packet flows to the correct destination address.

One of the systems is denoted AS#O and it is the originating autonomous system for a data session between an end-user connected to the internal communications network of AS#O to an end-user residing in another AS. Said end-users packet flows are routed by a source node, in the figure denoted node ON. The source node ON comprises a router and it may have a number of routes, or paths, to select for sending the data packet flows addressed to the other end-user. In the illustrated example, two internal paths, denoted ASO1 and ASO2, are available for said routing node AS#O for further transferring of data information in a data flow to the other end-user, who is residing in another AS, herein denoted as the terminating autonomous system AS#T. The path ASO1 connects the originating source node ON with a border node O11 comprising a Border Gateway Protocol (BGP) router. The path ASO2 connects the originating routing node ON with a border node O12 comprising a BGP router. An internal connection ASO3 connects the two border nodes O11, O12, which are internal peer nodes.

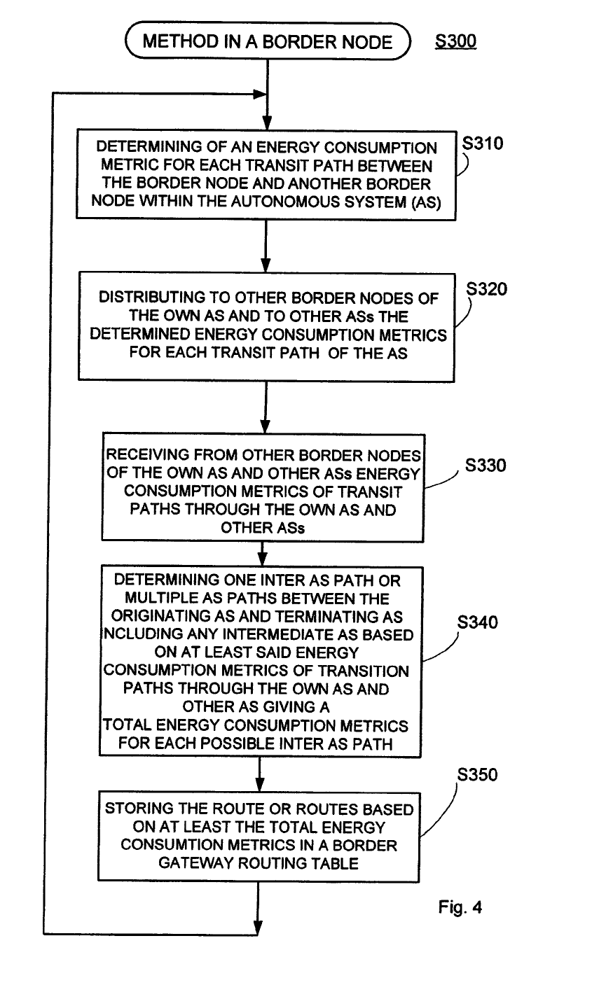

By means of the BGP routers in the border nodes, it is possible to connect to other autonomous systems having BGP routers. A peer connection between two BGP routers may be either a direct link, or an indirect link. The BGP protocol uses the Transfer Control Protocol (TCP) as transport protocol between BGP routers. This allows the BGP routers to establish BGP sessions and then exchange routing information using the messaging system. It is also the means by which the actual end user data traffic moves between autonomous systems. External peers are normally connected directly, while internal peers are often linked indirectly. In FIG. 1 (and FIG. 4) the connections between external peers are illustrated with continues lines, while connections between internal peers and internal nodes with dashed lines. When a BGP router in one AS is linked to a BGP router in another AS, they are denoted neighbours. The direct connection between them allows them to exchange information about the ASs of which they are a part. The neighbours exchange route information using the BGP messaging system. A BGP router may be connected to more than one other router. A BGP router may have relationship with other BGP routers both within its own AS and outside its AS. A neighbour within the AS is called an internal peer, while a neighbour in another AS is an external peer. BGP between internal peers is sometimes called Internal BGP (IBGP) while use of the protocol between external peers is denoted External BGP (EBGP).

According to the example of FIG. 1, AS#O is connected or linked to two other autonomous systems, AS#2 and AS#n. The BGP router of border node O11 in AS#O is connected via a link 11 to the BGP router of border node 211 in AS#2, and the BGP router of border node O12 of AS#O is connected via a link 21 to the BGP router of border node n11 in AS#n.

Autonomous system AS#2 comprises two BGP routers, one in border node 211 and one in border node 212, which are connected by a best path AS21 through AS#2. Autonomous system AS#2 is linked to autonomous system AS#3 by means of BGP router in border node 212 and BGP router 311 in border node in AS#3 via a link 12.

Autonomous system AS#3 comprises two BGP routers, one in border node 311 and one in border node 313, which are connected by a best path AS31 through AS#3. Autonomous system AS#3 is linked to autonomous system AS#T by means of BGP router in border node 313 and BGP router T11 in border node AS#T via a link 13.

Autonomous system AS#n comprises three BGP routers, one in border node n11, one in border node n12 and one in border node n13. Border node n11 is connected by a path ASn2 through AS#n to border node n13. Border node n11 is also connected by a path ASn1 through AS#n to border node n12. Autonomous system AS#n is linked to autonomous system AS#3 by means of BGP router in border node n12 and BGP router in border node 311 in AS#3 via a link 22. Autonomous system AS#n is further linked to autonomous system AS#T by means of BGP router in border node n13 and BGP router in border node T12 in AS#T via a link 23. Border nodes n12 and n13 are internal node and they are connected via path ASn3.

The receiving end-user in autonomous system AS#T is connected to the destination node TN, which is connected to border node T11 via path AST1 and to border node T12 via path AST2.

It should be understood, that a path or route through an AS may comprise one or more link interfaces and nodes. An internal path comprises a number of link interfaces and nodes. An inter AS path or inter AS route may involve the path from an originating Autonomous System (AS#O) to a terminating Autonomous System (AS#T), possibly via intermediate Autonomous Systems, as in this example: AS#n, AS#2 and AS#3.

The network topology of the illustrated example gives a number of different routes from the originating autonomous system AS#O to the terminating autonomous system AS#T. A number of routes are possible, for example:
Route 1: [ASO1,AS21,AS31,AST1];
Route 2: [ASO2,ASn1,AS31,AST1];
Route 3: [ASO2,ASn2,AST2];

The decision process in the border nodes and the policies which the decision process is based upon determines which of the routes that becomes the selected route. Routes learned via BGP have associated properties that are used to determine the best route to a destination when multiple paths exist. These properties are called BGP attributes as already mentioned herein. The following attributes may be used:
Weight;
Local preference;
Multi-exit discriminator;
Origin;
AS path;
Next-hop;
Community.
   Said path attributes are defined in a number of standard documents, e.g. IETF RFC4271.

The route selection may be based on policies, e.g. number of ASs traversed should be as few AS-hops as possible, wherein the number of AS-hops is considered as a path cost factor, a metric. The number of AS-hops for Route 1 is 3, for Route 2 is also 3, and for Route 3 only 2 hops. Thus, the result of the route selection in a border node comprising a BGP router using the number of AS-hops in the decision policy is Route 3. However, this might not be the most energy efficient route. Certain paths are however consuming more power than others which can result in traffic flowing over a high power consuming and long distance path, because this is the best path based on the existing metrics.

Thus, a path attribute, such as weight, may be related to one or more path cost factors, metrics. As an example, AS-hops is related to the path attribute AS path.

If an internal path comprises a number of link interfaces, each such link interface has an allocated link cost. Each link cost may be a sum of different link cost factors, i.e. different metrics. Examples of metrics, or link cost factors, may be the distance of a router, called round-trip time, network throughput of a link, e.g. bandwidth, and link availability and reliability. According to the following embodiments, said list of metrics is extended with a new metric with AS path energy consumption ECM_{ASROUTE} is Added.

A method for energy efficient routing and switching in a communication network has recently been filed, see application number PCT/SE2010/000308, filed 2010 Dec. 20. Said document teaches a node and a method to switch data also using Energy Consumption Metrics, ECM, which may be based on the power consumption in link interfaces, the links and in internal nodes. In the following description, said Energy Consumption Metric, ECM, in a link interface is denoted ECM_{LINK}.

The energy consumption metrics ECM_{LINK} is defined as a power consumption factor divided by the speed (bandwidth) for the link interface. The energy consumption metrics can for example be expressed by the unit watt/bits/s, watt/Gbit/s or nJ/bit.

The power consumption factor ECM_{LINK} allocated to an individual link interface could be determined by measurements or, if already known, for example by data sheets for the link interfaces. However, the metric ECM_{LINK} for a link interface may also be set or selected, e.g. by Internet Service Provider or Network Service Provider.

The power consumption factor can be different for different types of link interfaces but also for link interfaces of the same type but implemented differently (different micro processors etc) or coming from different vendors.

Thus, it is possible to determine the best paths between all possible border nodes in the autonomous system based on a total energy consumption metric for each path between two border nodes within said autonomous system. According to said method of patent application number, PCT/SE2010/000308, in a node of a routing area, e.g. an autonomous system, route selection metrics concerning link interfaces in a plurality of other nodes belonging to the same routing area as said node are received. A best path to all possible destination nodes in the communication network is determined based on at least the energy consumption metrics and stored in at least one routing table.

### Determining AS Transit Path and Related Energy Consumption Metric ECM_{BNP}:

A transit path is a path of link interfaces through an autonomous system. It is a connection of links between two border nodes of the AS. In FIG. 1, several transit paths are illustrated. For example, in AS#2, one transit path is available between border nodes 211 and 212. In AS#n, three transit paths are available: ASn1, ASn2 and ASn3. Each transit path has an allocated energy consumption metric, ECM_{BNP}, wherein BNP, Border Node Pair, may be an identity of the path (e.g. ASn1) and/or the AS (e.g. AS#1).

Each border node may be configured to determine one transit path of all possible paths between the border node itself and other border nodes in its autonomous system. Said determination, e.g. by selection, may be based on at least an energy consumption metric, e.g. ECM_{BNP} for each path within said autonomous system. ECM_{BNP} is herein denoted AS transit energy consumption metric. The method may be described as follows:

The power consumption metric ECM_{BNP} allocated to an internal, individual transit path between the border node and another border node may be determined by summing the ECM_{LINK} metrics of the link interfaces using an interior gateway protocol which constitute the path. However, the metric ECM_{BNP} for an internal transit path may also be set or selected, e.g. by Internet Service Provider or Network Service Provider. The selected transit path between said pair of border nodes is determined in the decision process by means of a policy or a number of policy rules. Such a policy may be that the transit path is the path with the lowest ECM_{BNP}. Another selection policy rule that may be used in the route selection process for determining the transit path is the path having the most favourable total link cost of a combination of different link and path costs e.g. ECM_{LINK}, link weight, etc. The transit path selected between two border nodes is determined according to the used criteria, i.e. policy. The method is repeated in the border node for each of the other border nodes within its AS. The selected transit path from one border node to another border node is identified and stored in the routing table of the border node. At least the energy consumption metrics ECM_{BNP} for the selected transit path may be distributed to other border nodes both within the AS and to border nodes of other ASs.

Each border node may be configured to receive at least the transit path energy consumption metrics ECM_{BNP} of other Autonomous Systems from other border nodes, peer nodes.

### Determining Inter AS Path and Related Total Energy Consumption Metric ECM_{ASROUTE}:

Each border node may also be configured to determine one inter autonomous system path between the originating Autonomous System AS#O and terminating Autonomous System AS#T including any intermediate Autonomous System based on a total energy consumption metrics. In FIG. 1, a number of Inter AS paths are illustrated, for example:
[ASO1,AS21,AS31,AST1];
[ASO2,ASn1,AS31,AST1];
[ASO2,ASn2,AST2];

The one inter autonomous system path selected may be determined by calculating the total energy consumption metric ECM_{ASROUTE} for each possible inter autonomous system path.

The node is configured to determine the best inter autonomous system path between the originating Autonomous System AS#O and terminating Autonomous System AS#T including any intermediate Autonomous System based on at least said total energy consumption metrics ECM_{ASROUTE} of the autonomous systems. Said determination may be performed by calculating the total energy consumption metric for each possible inter autonomous system path. The route of the selected inter autonomous system path between the originating Autonomous System AS#O and terminating Autonomous System AS#T including any intermediate Autonomous System may be determined as the inter autonomous system path having the lowest total energy consumption metric or the inter autonomous system path having at least the lowest total energy consumption metric ECM_{ASROUTE} of all possible Inter AS paths.

The method may be described as follows: The power consumption factor ECM_{ASROUTE} allocated to certain inter AS path may be determined by summing the ECM_{BNP} metrics of the ASs constituting a certain path. However, the metric ECM_{BNP} for a certain transit path in an AS may also be set or selected, e.g. by Internet Service Provider or Network Service Provider. The best path between the originating Autonomous System AS#O and terminating Autonomous System AS#T may be determined in the decision process by means of a policy or a number of policy rules. Such a policy may be that the best path is the path with the lowest ECM_{ASROUTE}. Another selection policy rule that may be used in the route selection process for determining the best path is the path having the most favourable total link cost of a combination of different link costs e.g. ECM_{BNP}, link weight, etc. The best path between the originating Autonomous System AS#O and terminating Autonomous System AS#T is selected according to the used criteria, i.e. policy, The method is repeated in the border node for each possible route between the originating Autonomous System AS#O and terminating Autonomous System. Said best path from one border node to another border node is identified and stored in the routing table of the border node.

If multiple equal cost paths exist between AS#O and AS#T, the normal BGP process selects only one path as the best path. BGP also supports multipath as an option, in that case BGP stores multiple paths in the routing table to allow for equal cost multiple path load sharing.

Thus, at the intra routing area level, the Energy Consumption Metric ECM_{LINK} is introduced as a link cost factor to select a path that uses least energy. The node energy consumption attribute may be provided by the router vendor calculating the total power consumption of multiple routers plus the interface energy cost ECM for the AS. On the Inter AS level a new metric, ECM_{BNP}, with AS path energy consumption is added.

The ECM_{BNP} parameter may be added as a new attribute, for example to an extended AS_PATH, AS6_{—} PATH (6 octets), or modification of any existing attribute to be used by BGP to communicate and find out the most energy efficient AS path.

The implementation can either gather the information on energy cost from Interior Gateway Protocol (IGP) or can be set as a policy to communicate AS domain energy consumption to the peer ASs.

Thus, it is possible to determine an energy cost ECM_{BNP} for each transit path between internal peer nodes. If an AS transit path comprises a number of link interfaces, each such link interface has an allocated link cost.

According to some embodiments, an energy consumption metric ECM_{BNP} for a path between different border node pairs within the Autonomous System, i.e. pair of internal peers, is calculated by summing the allocated link cost, in this case the energy consumption metric, for each link interface.

According to other embodiments, an energy consumption metric for each path between different border node pairs within the Autonomous System is determined by selecting an energy consumption metric defined by a policy for said path and/or AS.

In FIG. 1 is illustrated different border node pairs, i.e. pair of internal peers, and the path between them within each autonomous system. An AS transit energy consumption metric ECM_{BNP} is allocated to each path between said internal peers. In autonomous system AS#O, a pair of border nodes O11, O12 is illustrated. The transit path ASO3 between said pair of BGP peers has the AS transit energy consumption metric ECM_{BNP}=250.

The autonomous system AS#2, has a pair of border nodes 211, 212. The transit path AS21 between said pair of BGP peers has the AS transit energy consumption metric ECM_{BNP}=100. Further, the autonomous system AS#3, has a pair of border nodes 311, 313. The transit path AS31 between said pair of BGP peers has the AS transit energy consumption metric ECM_{BNP}=100.

In autonomous system AS#T, a pair of border nodes T11, T12 is illustrated. The transit path AST1 between said pair of BGP peers has the energy consumption metric ECM_{BNP}=300.

Finally, in FIG. 1, the autonomous system AS#n has three border nodes n11, n12 and n13. Thus, AS#n has three pairs of border nodes, n11-n12, n11-n13 and n12-n13 being end points of each connecting path ASn1, ASn2 and ASn3. The transit path ASn1 between said pair of BGP peers has the energy consumption metric ECM_{BNP}=250. The transit path ASn2 between said pair of BGP peers has the energy consumption metric ECM_{BNP}=300, and the internal path ASn3 has the AS transit energy consumption metric ECM_{BNP}=300.

The network topology of the illustrated example gives a number of different routes from the originating autonomous system AS#O to the terminating autonomous system AS#T. A number of routes are possible, for example:
Route 1: [ASO1,AS21,AS31,AST1];
Route 2: [ASO2,ASn1,AS31,AST1];
Route 3: [ASO2,ASn2,AST2];

The total energy consumption metric ECM_{ASROUTE} is for Route 1 comprising paths ASO1,AS2,AS31 and AST1 is ECM_{ASROUTE}=0+100+100+0=200 as the ECM for AS2 and AS31 is 100. Paths ASO1 and AST1 are not paths between internal peers, i.e. border nodes, and therefore, they will not be contribute to the link cost, total energy consumption metric ECM_{ASROUTE}.

In the similar way, for Route 2: [ASO2,ASn1,AS31,AST1] the total energy consumption metric is ECM_{ASROUTE}=0+250+100+0=350. The ECM for route 2 is higher than for route 1.

In the similar way, for Route 3: [ASO2,ASn2,AST2] the total energy consumption metric is ECM_{ASROUTE}=0+300+0=300.

Thus, the ECM_{ASROUTE} for route 1 is the lowest for the three routes, and it is considered as the best path of the three based on the total energy consumption metric ECM. In an example, the selection of the best route/path was based on the path cost AS-hops. The number of AS-hops for Route 1 was 3, for Route 2 was also 3, and for Route 3 only 2 hops. Thus, the result of the route selection in a border node comprising a BGP router using the number of AS-hops in the decision policy was Route 3.

In further one example, not illustrated, Route 3 involves 4 hops, Route 1 3 hops, and for Route 2 also 3 hops. If the selection of a route was based upon AS-hops and the total energy consumption metric is ECM_{ASROUTE} according to a decision policy stating a selection of the route having smallest number of AS-hops and the lowest ECM_{ASROUTE}, As both Route 1 and Route 2 involves 2 hops, the total energy consumption metric ECM_{ASROUTE} for Route 1 is the lowest of the two routes. Thus, in this case Route 1 is selected.

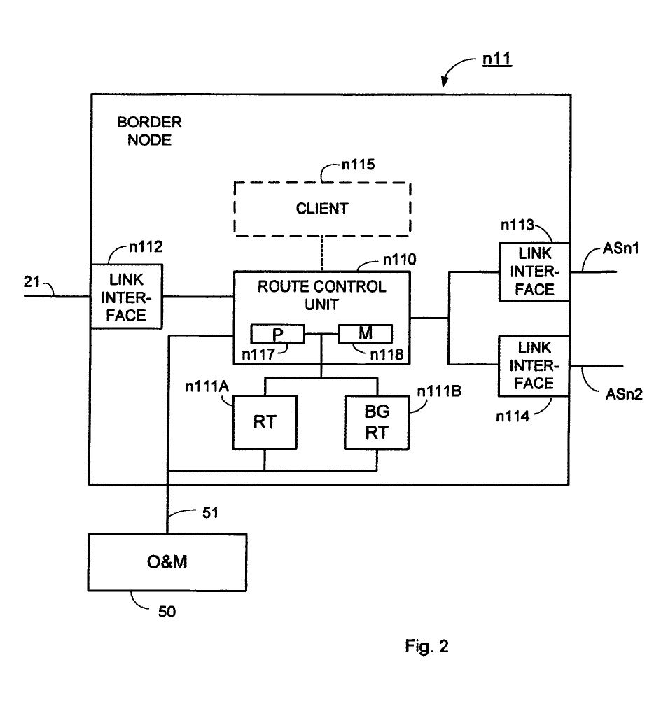

FIG. 2 illustrates embodiments of a border node 211 configured for energy efficient routing or switching. A border node, also denoted BGP node, comprises a route control unit for management and handling of routing information which is stored in a database. The routes are stored in a routing table, but it may not be a monolithic entity. The node 211 comprises three link interfaces n112, n113, n114 each connected to a link 21, ASn1, ASn2. The link interfaces are adapted to be allocated route selection metrics including energy consumption metrics ECM. The link interfaces n112, n113, n114 are connected to a route control unit n110. This route control unit n110 makes the routing decisions and calculates the best paths to different destinations. The best paths are stored in a routing table which is accessible by the route control unit. A path selected according to a certain criteria or policy rule is defined as the best path according to said criteria or policy rule. In the illustrated embodiment, the routing table involves two entities, a Routing Table, RT, n111A and a Border Gateway Routing Table, BGRT, n111 B. In the Routing Table, RT, n111A is internal routing information stored. Internal routing information is intra-routing information about best paths, e.g. ECM_{LINK}, within the routing area, i.e. the autonomous system. In the Border Gateway Routing Table, BGRT, n111A is external routing information stored. External routing information is inter AS routing information, e.g. ECM_{ASROUTE} and ECM_{BNP} about best paths from one routing area to another routing area, and the best paths to traverse the autonomous systems.

The route control unit n110 is preferable implemented as a processor P n117 with a memory area M n118 comprising executable code adapted to perform the functions described above and below. The route selection metrics including energy consumption metrics ECM_{LINK}, ECM_{ASROUTE} and ECM_{BNP}, can for example be stored in the memory area n118 or in the routing tables n111A, n111 B. The route selection metrics are allocated from an O&M center 50 through an operation and management interface 51 in the node n11. The link interfaces n112, n113, n114 are adapted to receive and send data packets and also routing protocol packets. The link interfaces n112, n113, n114 can for example receive route selection metrics concerning link interfaces from other peer nodes belonging to other autonomous system. The route selection metrics, optionally including energy consumption metrics, are received by means of the BGP messaging system, e.g. in Update messages or Open messages. When the link interfaces n112, n113, n114 in node n11 are allocated energy consumption metrics, the node n11 may optionally send these metrics in update messages to the other peer nodes belonging to other ASs.

The basic functionality of node n11 is to receive packets from nodes in the communication network of its own AS and from neighbour nodes, such as BGP nodes and external peer nodes, in other ASs, and to route these packets further to other internal nodes or to neighbour nodes in other ASs. It is also possible that the node itself comprises a client n115 that can originate and terminate data packets. A request to send a packet can therefore also be received by the route control unit n110 as a protocol primitive from the client n115.

The route control unit may be implemented in digital electronically circuitry, or in computer hardware, firmware, software, or in combinations of them. Devices may be implemented in a computer program product tangibly embodied in a machine readable storage device for execution by a programmable processor; and method steps of the invention may be performed by a programmable processor executing a program of instructions to perform functions of the invention by operating on input data and generating output.

Embodiments of the route control unit may advantageously be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language.

Generally, a processor will receive instructions and data from a read-only memory and/or a random access memory. Storage devices suitable for tangibly embodying computer program instructions and data include all forms of non-volatile memory, including by way of example semiconductor memory devices, such as EPROM, EEPROM, and flash memory devices; magnetic disks such internal hard disks and removable disks; magneto-optical disks; and CD-ROM disks. Any of the foregoing may be supplemented by, or incorporated in, specially—designed ASICs (Application Specific Integrated Circuits).

The above described embodiments of node structures are configured to support embodiments of a method for storing the route of the best inter autonomous systems paths based on at least energy consumption metrics in a border gateway routing table.

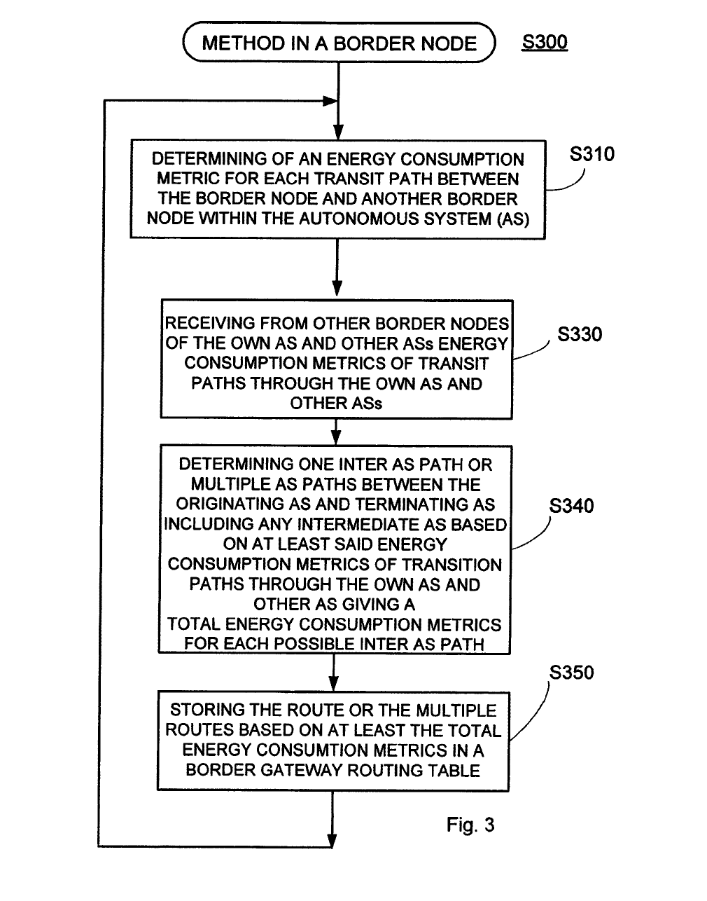

FIG. 3 is a flowchart illustrating embodiments of said method.

Thus, a border node n11 (see FIG. 1) of an autonomous system AS#n comprises a border route control unit n110 (see FIG. 1) for routing data packets from a source node ON in a originating autonomous system AS#O to a destination node TN in a terminating autonomous system AS#T, possibly via intermediate autonomous systems. The method is hereafter described in more details.

S310: Determining an energy consumption metric ECM_{BNP} for each AS transit path between the border node and another border node within the autonomous system. Each border node and its route control unit n110 may be configured to determine the best transit paths or best transit paths of all possible paths between itself and other border nodes in its autonomous system based on at least the determined energy consumption metric ECM_{BNP} for each path within said autonomous system. In the section “Determining AS Transit path and related energy consumption metric ECM_{BNP}” in the present description, examples of methods for determining energy consumption metric ECM_{BNP} and corresponding AS transit paths are discussed.

S330: Receiving from other border nodes of the own autonomous system and from other autonomous systems energy consumption metrics ECM_{BNP} of transit paths through the own autonomous system and from other autonomous systems. The route control unit is configured to receive total energy consumption metrics from other border nodes, peer nodes. Said metrics may be received in any of the ways described above in S320, i.e. for distributing energy consumption metrics. In RFC 4893 the Autonomous System Number ASN is extended to encode numbers of four octets instead of two-octet numbers. According to some embodiments, the energy consumption metrics ECM_{BNP} for a path through the autonomous system may be added to an un-used part of the ASN. For BGP routers in border nodes not supporting the four-octet AS numbers, new attributes are introduced that may be used to distribute and propagate four octet based AS path information. According to some embodiments, the distribution of energy consumption metrics for paths through autonomous systems ASn:s is performed by means of a predetermined attribute of Border Gateway Protocols BGP. The attribute may be any AS_PATH, e.g. AS4_PATH, or AS6_PATH. AS6_PATH is an AS_PATH attribute extended to six octets length for distributing the total energy consumption metrics of the autonomous system to other systems. In a similar way, the existing AS4_PATH is modified for distributing the energy consumption metrics ECM_{BNP} for a path through the Autonomous System to other systems, e.g. in the most significant byte of the attribute. According to other embodiments, the attribute may be any AS_AGGREGATOR. e.g. AS4_AGGREGATOR, which is a AS_AGGREGATOR attribute extended from 2-octet length to 4-octet length to include/comprise the energy the energy consumption metrics. The AS_PATH is classified as a well-known mandatory attribute and it is a list of Autonomous System Numbers ASN that describes the sequence of ASs through which the attribute has passed. This is a critically important attribute, since it contains the actual path of autonomous systems. It is used to calculate routes and to detect routing loops. The AS_AGGREGATOR is classified as an optional transitive attribute and contains the AS number and BGP ID of the router that performed route aggregation. It is used for troubleshooting.

S340: Determining one inter autonomous system path or multiple inter AS paths constituting a route or multiple routes, respectively, between the originating autonomous system AS#O and terminating autonomous system AS#T including any intermediate autonomous system based on at least said energy consumption metrics ECM_{BNP} of transit paths through the own autonomous system and other autonomous systems giving a total energy consumption metric ECM_{ASROUTE} for each possible inter autonomous system path. The route control unit is configured to determine the best inter autonomous system path or paths between the originating autonomous system AS#O and terminating autonomous system AS#T comprising any intermediate autonomous system based on a total energy consumption metric ECM_{ASROUTE} which may be calculated for each possible inter autonomous system path. The route having the lowest total energy consumption metric is defined as the best inter autonomous system path. However, two or more routes may have the same total energy consumption metric ECM_{ASROUTE}. Policies may than allow multiple routes between the originating autonomous system AS#O and terminating autonomous system AS#T including any intermediate autonomous system. In the section “Determining inter AS path and related energy consumption metric ECM_{ASROUTE}” in the present description, examples of methods for determining energy consumption metric ECM_{ASROUTE} and corresponding inter AS paths are discussed.

S350: Store in a routing table n111B in the node the route or multiple routes based on at least the total energy consumption metrics ECM_{ASROUTE}. Said routing table is preferably a border gateway routing table. Thus, when the best inter autonomous system path or paths has been determined (in S340), the route control unit is configured to store in a border gateway routing table n111B in the node the route of the best inter autonomous systems path or routes of the best inter autonomous systems path based on at least the energy consumption metrics. Said route or multiple routes are then selectable by the border route control unit for routing and sending data packets from a source node ON in an originating Autonomous System AS#O to a destination node TN in a terminating Autonomous System AS#T, possibly via intermediate Autonomous Systems.

When receiving a request to send a packet to a specific destination node, the node selects from the border gateway routing table the link interface connected to the link belonging to the best path to the specific destination node from an energy consumption point of view, e.g. the inter autonomous system path(s) with the lowest total energy consumption metric ECM_{ASROUTE}. After selecting the link interface, the packet is sent towards the destination node via the selected link interface.

FIG. 4 is a flowchart illustrating further embodiments of the present method. These embodiments involve the steps S310, S330, S340 and S350, as described above in connection with flowchart 3. It is obvious from the flowchart in FIG. 4 that the further embodiments of the present method comprise a step 320, which now will be described in more detail.

S320: Distributing the energy consumption metrics ECM_{BNP} of AS transit paths to border nodes of the own autonomous system and other autonomous systems. The route control unit n110 in the border node is configured to distribute the energy consumption metrics ECM_{BNP} of AS transit paths to border nodes of the own autonomous system and other autonomous systems e.g. by means of messages in the BGP system. According to some embodiments, the distribution and reception of energy consumption metrics of autonomous systems ASn:s may be performed by means of any protocol. Other proposed ways of distributing is discussed above, see S320, in the present description.

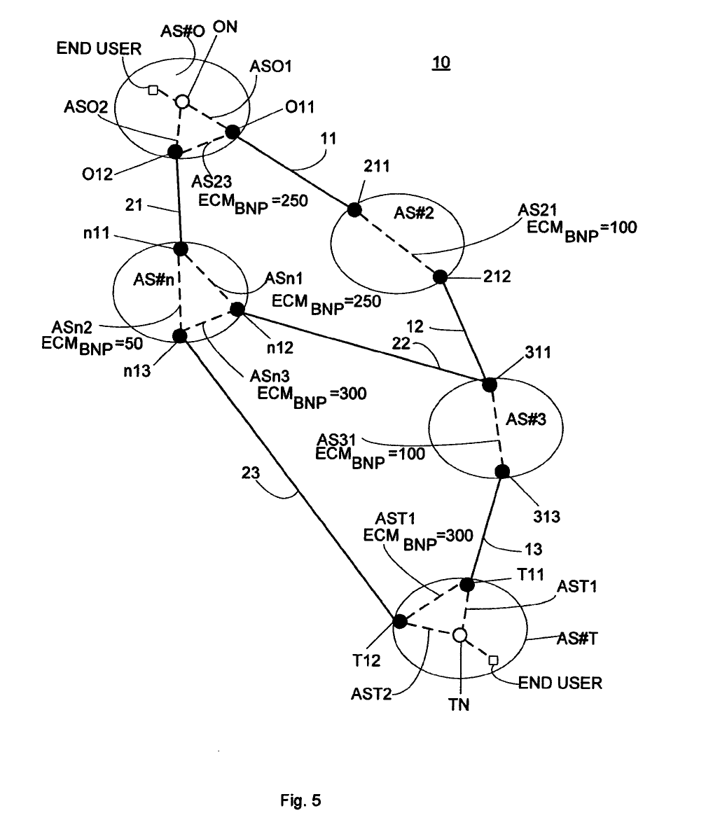

FIG. 5 is illustrating the same interworking AS structure as in FIG. 1. The difference is that the energy consumption metrics path ASn2 has been changed from ECM_{BNP}=300 to ECM_{BNP}=50. The new ECM_{BNP} value is distributed in accordance to any embodiment of the described method. Following routes are considered again:
Route 1: [ASO1,AS21,AS31,AST1];
Route 2: [ASO2,ASn1,AS31,AST1];
Route 3: [ASO2,ASn2,AST2];
Which route is now the best path with the new ECM_{ASROUTE} value of ASn2 of AS#n?

The total energy consumption metric for Route 1 comprising paths ASO1,AS21,AS31 and AST1 is still ECM_{ASROUTE}=0+100+100+0=200 as the ECM_{BNP} for AS21 and AS31 is 100. Paths ASO1 and AST1 are not paths between internal peers, i.e. border nodes, and therefore, they will not contribute to the link cost total energy consumption metric ECM_{ASROUTE}

In the similar way, for Route 2: [ASO2,ASn1,AS31,AST1] the total energy consumption metric is ECM_{ASROUTE}=0+250+100+0=350. The ECM for route 2 is higher than for route 1.

In the similar way, for Route 3: [ASO2,ASn2,AST2] the total energy consumption metric is ECM_{ASROUTE}=0+50+0=50.

Thus, the ECM_{ASROUTE} for route 3 is now the lowest for the three routes, and it is considered as the best path through the ASs in the internetwork of the three based on the total energy consumption metric ECM_{ASROUTE} for a route.

A number of embodiments have been described. It will be understood that various modifications may be made without departing from the scope of the following claims.

1. A method in a border node of an autonomous system (AS), the border node is configured for routing data packets from a source node in an originating Autonomous System to a destination node in a terminating Autonomous System, possibly via intermediate autonomous systems, the method comprising:
determining an energy consumption metric for each transit path between the border node and another border node within the autonomous system;
receiving from other border nodes of an own autonomous system and from other autonomous systems energy consumption metrics of transit paths through the own autonomous system and other autonomous systems;
determining one inter autonomous system path or multiple inter AS paths constituting a route or multiple routes, respectively, between the originating autonomous system and terminating autonomous system including any intermediate autonomous system based on at least said energy consumption metrics of transit paths through the own autonomous system and other autonomous systems giving a total energy consumption metric for each possible inter autonomous system path; and
storing the route or multiple routes based on at least the total energy consumption metrics in a routing table in the border node.

2. The method according to claim 1, further comprising:
distributing, to other border nodes of the own autonomous system and to other autonomous systems, the determined energy consumption metrics for each transit path of the autonomous system.

3. The method according to claim 1, wherein the determining of an energy consumption metric for each transit path between the border node and another border node within the autonomous system is performed by selecting, for each border node pair, one transit path between them defined by a policy for said path.

4. The method according to claim 2, wherein the distribution and reception of energy consumption metrics of transit paths in autonomous systems is performed by means of any protocol.

5. The method according to claim 4, wherein the distribution of energy consumption metrics of transit paths in autonomous systems is performed by means of a predetermined attribute of Border Gateway Protocols (BGP).

6. The method according to claim 5, wherein the attribute is any AS_PATH.

7. The method according to claim 5, wherein the attribute is any AS_AGGREGATOR.

8. A border node of an autonomous system (AS), the border node comprising a border route control unit for routing data packets from a source node in an originating autonomous system to a destination node in a terminating autonomous system, possibly via intermediate autonomous systems, said border route control unit is configured to:
determine an energy consumption metric for each transit path between the border node and another border node within the autonomous system;
receive from other border nodes of an own autonomous system and from other autonomous systems energy consumption metrics of transit paths through the own autonomous system and other autonomous systems;
determine one inter autonomous system path or multiple inter AS paths constituting a route or multiple routes, respectively, between the originating autonomous system and terminating autonomous system including any intermediate autonomous system based on at least said energy consumption metrics of transit paths through the own autonomous system and other autonomous systems giving a total energy consumption metric for each possible inter autonomous system path; and
store the route or multiple routes based on at least the total energy consumption metrics in a routing table in the border node.

9. The border node according to claim 8, wherein the border route control unit is further configured to distribute to other border nodes of the own autonomous system and to other autonomous systems the determined energy consumption metrics for each transit path of the autonomous system.

10. The border node according to claim 8, wherein the border route control unit is further configured to determine an energy consumption metric for each transit path between the border node and another border node within the autonomous system is performed by selecting, for each border node pair, one transit path between them defined by a policy for said path.

11. The border node according to claim 9, wherein the border route control unit is configured to distribute and receive energy consumption metrics of transit paths in autonomous systems by means of any protocol.

12. The border node according to claim 11, wherein the border route control unit is configured to distribute and receive energy consumption metrics of transit paths in autonomous systems by means of a predetermined attribute of Border Gateway Protocols (BGP).

13. The border node according to claim 12, wherein the attribute is any AS_PATH.

14. The border node according to claim 12, wherein the attribute is any AS_AGGREGATOR.
